(19) United States
(12) Patent Application Publication
(10) Pub. No.: US 2024/0278555 A1
(43) Pub. Date: Aug. 22, 2024

(54) HEAD DRIVING DEVICE, LIQUID DISCHARGE DEVICE, LIQUID DISCHARGE APPARATUS, AND METHOD FOR DISCHARGING LIQUID

(71) Applicant: Yoshihito OTOI, Tokyo (JP)

(72) Inventor: Yoshihito OTOI, Kanagawa (JP)

(21) Appl. No.: 18/291,252

(22) PCT Filed: Aug. 5, 2022
(86) PCT No.: PCT/IB2022/057294

§ 371 Date: Jan. 23, 2024

(30) Foreign Application Priority Data
Aug. 20, 2021 (JP) 2021-134726
Apr. 13, 2022 (JP) 2022-066048

(51) Int. Cl. B41J 2/045

(52) U.S. Cl. CPC B41J 2/04563; B41J 2/04581; B41J 2202/05

(57) ABSTRACT

A head driving device is coupled to a head unit to discharge a liquid from a nozzle. The head driving device includes a voltage application unit and circuitry. The voltage application unit applies a voltage to the head unit including a valve that moves between a nozzle open position to open the nozzle and a nozzle close position to close the nozzle, an actuator that moves the valve, and a temperature detector that detects a temperature of the actuator. The circuitry causes the voltage application unit to: apply a first voltage to the actuator to move the valve to the nozzle close position; apply a second voltage different from the first voltage to the actuator to move the valve to the nozzle open position; and vary the second voltage based on the temperature detected by the temperature detector.

### TECHNICAL FIELD

Embodiments of the present disclosure relate to a head driving device, a liquid discharge device, a liquid discharge apparatus, and a method for discharging a liquid.

### BACKGROUND ART

PTL 1 discloses a liquid discharge head that pressurizes a discharge liquid to be discharged from a nozzle and supplies the discharge liquid to a cavity communicating with the nozzle. The liquid discharge head includes a pin that closes the nozzle, an actuator that causes the pin to contact and separate from the nozzle, and a controller that controls the actuator. The discharge liquid is discharged from the nozzle as liquid droplets only while the pin is separated from the nozzle.

However, the liquid discharge head having such a configuration may fail to discharge the liquid.

### CITATION LIST

### Patent Literature

[PTL 1]

Japanese Unexamined Patent Application Publication No. 2010-241003

### SUMMARY OF INVENTION

### Technical Problem

An object of the present disclosure is to provide a head driving device that is less likely to fail to discharge a liquid.

### Solution to Problem

A head driving device is coupled to a head unit to discharge a liquid from a nozzle. The head driving device includes a voltage application unit and circuitry. The voltage application unit applies a voltage to the head unit. The head unit includes a valve that moves between a nozzle open position to open the nozzle and a nozzle close position to close the nozzle, an actuator that moves the valve, and a temperature detector that detects a temperature of the actuator. The circuitry causes the voltage application unit to apply a first voltage to the actuator to move the valve to the nozzle close position not to discharge the liquid from the nozzle, causes the voltage application unit to apply a second voltage different from the first voltage to the actuator to move the valve to the nozzle open position to discharge the liquid from the nozzle, and causes the voltage application unit to vary the second voltage based on the temperature detected by the temperature detector.

According to other embodiments of the present disclosure, there is provided a liquid discharge device that includes a liquid discharge head, a temperature detector, a voltage application unit, and circuitry. The liquid discharge head includes a valve that moves between a nozzle open position to open the nozzle and a nozzle close position to close the nozzle, and an actuator that moves the valve. The temperature detector detects a temperature of the actuator. The voltage application unit applies a voltage to the actuator. The circuitry causes the voltage application unit to apply a first voltage to the actuator to move the valve to the nozzle close position not to discharge the liquid from the nozzle, causes the voltage application unit to apply a second voltage different from the first voltage to the actuator to move the valve to the nozzle open position to discharge the liquid from the nozzle, and causes the voltage application unit to vary the second voltage based on the temperature detected by the temperature detector.

According to yet other embodiments of the present disclosure, there is provided a method for discharging a liquid by a liquid discharge head. The method includes moving a valve of the liquid discharge head between a nozzle open position to open a nozzle of the liquid discharge head and a nozzle close position to close the nozzle, applying a voltage to an actuator of the liquid discharge head to move the valve. The applying the voltage includes: applying a first voltage to the actuator to move the valve to the nozzle close position not to discharge the liquid from the nozzle and applying a second voltage different from the first voltage to the actuator to move the valve to the nozzle open position to discharge the liquid from the nozzle. The method further includes detecting a temperature of the actuator and varying the second voltage based on the temperature detected by the detecting.

### Advantageous Effects of Invention

According to the present disclosure, the head driving device can be provided that is less likely to fail to discharge a liquid.

### BRIEF DESCRIPTION OF DRAWINGS

A more complete appreciation of the embodiments and many of the attendant advantages and features thereof can be readily obtained and understood from the following detailed description with reference to the accompanying drawings

FIG. 1 is a cross-sectional view illustrating an interior of a liquid discharge head according to an embodiment of the present disclosure.

FIG. 2 is a schematic cross-sectional view of one liquid discharge module of the liquid discharge head.

FIGS. 3A and 3B are schematic enlarged views of a part of the liquid discharge module and graphs of a voltage applied to a piezoelectric element when a needle valve is opened and closed in the liquid discharge module.

FIG. 4 is a graph of the voltages applied to the piezoelectric element before and after correction.

FIG. 5 is a block diagram of a head driving device according to an embodiment of the present disclosure.

FIG. 6 is a flowchart of voltage correction according to an embodiment of the present disclosure.

FIGS. 7A and 7B are schematic cross-sectional views illustrating a modification of the liquid discharge head and the head driving device according to an embodiment of the disclosure.

FIG. 8 is a schematic perspective view of a liquid discharge apparatus according to an embodiment of the present disclosure.

FIG. 9 is a schematic perspective view of a carriage of the liquid discharge apparatus illustrated in FIG. 8.

FIG. 10 is a block diagram illustrating an example of a control system of the liquid discharge apparatus.

FIG. 11 is a schematic view of a liquid discharge apparatus according to another embodiment of the present disclosure.

FIG. 12 is an enlarged view of the liquid discharge apparatus illustrated in FIG. 11.

FIG. 13 is a block diagram illustrating another modification of the head driving device according to an embodiment of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

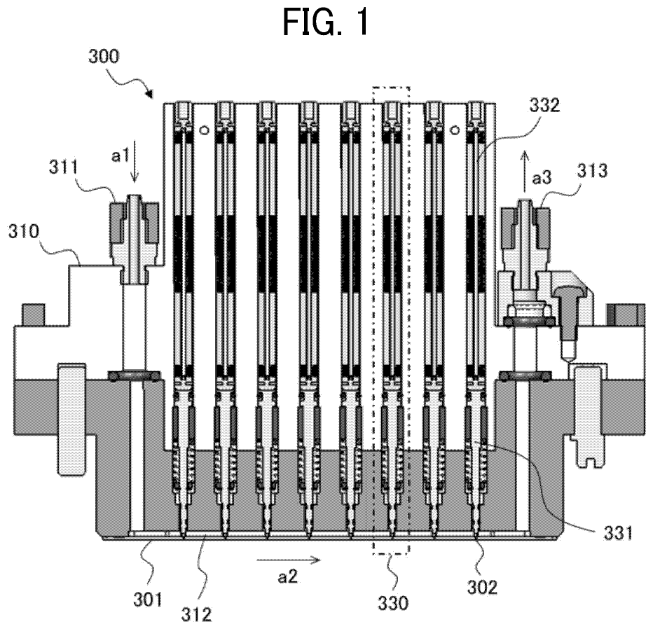

Embodiments of the present disclosure are described below with reference to the drawings. FIG. 1 is a cross-sectional view illustrating an interior of a liquid discharge head 300 according to an embodiment of the present disclosure.

The liquid discharge head 300 (hereinafter, simply referred to as a head 300) includes a housing 310 formed of a metal material or a resin material. The housing 310 includes a liquid supply port 311 through which liquid is supplied into the head 300 and a liquid collection port 313 through which the liquid is drained from the head 300. The housing 310 holds a nozzle plate 301 having nozzles 302 to discharge liquid. The housing 310 has a liquid chamber 312 that also serves as a flow path through which liquid is fed. The liquid is supplied from the liquid supply port 311 into the head 300 and fed to the liquid collection port 313 along the nozzle plate 301 in the liquid chamber 312.

The head 300 includes liquid discharge modules 330 to discharge liquid in the liquid chamber 312 from the nozzles 302. The liquid discharge modules 330 are disposed between the liquid supply port 311 and the liquid collection port 313. The number of the liquid discharge modules 330 matches the number of the nozzles 302 on the nozzle plate 301. In the present embodiment, the eight liquid discharge modules 330 correspond to the eight nozzles 302 arranged in a row, respectively.

With the above-described configuration, pressurized liquid is taken into the liquid supply port 311 from the outside of the head 300, fed in the direction indicated by arrow a1 in FIG. 1, and supplied to the liquid chamber 312. The liquid supplied from the liquid supply port 311 is fed along the nozzle plate 301 in the direction indicated by arrow a2 in FIG. 1 in the liquid chamber 312. Then, the liquid that is not discharged from the nozzles 302 arranged along the liquid chamber 312 is drained through the liquid collection port 313 in the direction indicated by arrow a3 in FIG. 1.

The liquid discharge module 330 includes a needle valve 331 that opens and closes the nozzle 302 and a piezoelectric element 332 that drives the needle valve 331. As the piezoelectric element 332 is driven to move the needle valve 331 upward in FIG. 1, the nozzle 302 that has been closed by the needle valve 331 is opened to discharge liquid from the nozzle 302. As the piezoelectric element 332 is driven to move the needle valve 331 downward in FIG. 1, a tip of the needle valve 331 comes into contact with the nozzle 302 to close the nozzle 302 so that liquid is not discharged from the nozzle 302. The head 300 may temporarily stops draining liquid from the liquid collection port 313 while discharging the liquid to a liquid application target from the nozzles 302 to prevent a decrease in a liquid discharge efficiency from the nozzle 302. The needle valve 331 is an example of a valve, and the piezoelectric element 332 is an example of an actuator according to the present disclosure.

As described above, in the head 300 according to the present embodiment, the nozzle plate 301 includes multiple nozzles 302, and the multiple needle valves 331 and the multiple piezoelectric elements 332 are provided for the multiple nozzles 302, respectively. The head 300 including the multiple nozzles 302 can apply liquid to the liquid application target at high speed. Such a configuration is one example, and the number and an arrangement of the nozzles 302 and the liquid discharge modules 330 are not limited to eight as described above. For example, the number of the nozzles 302 and the liquid discharge modules 330 may be nine or more, or one rather than plural. Further, the nozzles 302 and the liquid discharge modules 330 may be arranged in multiple rows instead of one row.

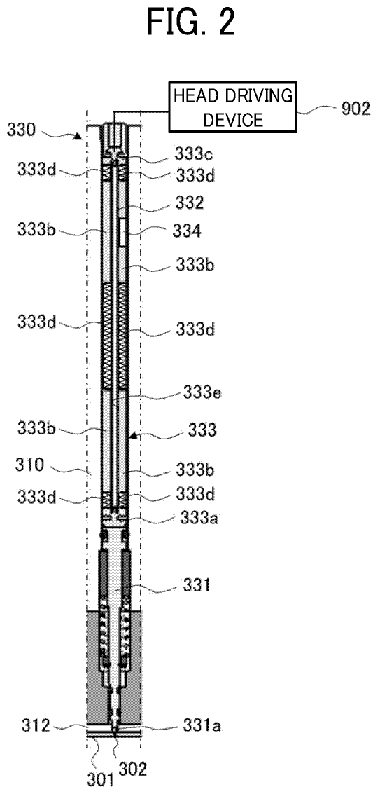

FIG. 2 is a schematic cross-sectional view of one liquid discharge module 330 of the head 300. As described above, the liquid discharge module 330 includes the needle valve 331 that opens and closes the nozzle 302 of nozzle plate 301 and the piezoelectric element 332 that drives the needle valve 331. The liquid chamber 312 defines the flow path shared with the multiple liquid discharge modules 330 in the housing 310.

The needle valve 331 includes an elastic member 331a at a tip of the needle valve 331. The elastic member 331a is deformed when pressed against the nozzle 302, thereby reliably closing the nozzle 302. The piezoelectric element 332 and the needle valve 331 are arranged on the same axis and coupled to each other via a coupling 333.

The coupling 333 includes a needle-valve coupling portion 333a, a frame portion 333b, a housing contact portion 333c, and an expansion portion 333d, and defines a space 333e. The needle-valve coupling portion 333a holds a rear end (an upper end in FIG. 2) of the needle valve 331. The needle-valve coupling portion 333a, multiple frame portions 333b, the housing contact portion 333c, and multiple expansion portions 333d are continuous so as to enclose the periphery of the space 333e, thereby constructing the coupling 333 having one-piece body. The piezoelectric element 332 is held in the space 333e of the coupling 333. The liquid discharge module 330 is provided with a thermistor 334 that detects the temperature of the piezoelectric element 332. In the present embodiment, the thermistor 334 is attached to a portion of the piezoelectric element 332. The thermistor 334 is an example of a “temperature detector” according to the present disclosure.

In the liquid discharge module 330 according to the present embodiment, when a head driving device 902 applies a voltage VH to the piezoelectric element 332, the piezoelectric element 332 expands and pushes the needle valve 331 toward the nozzle 302 via the coupling 333. As a result, the needle valve 331 is positioned at a nozzle close position to close the nozzle 302. When the head driving device 902 applies a voltage VL lower than the voltage VH to the piezoelectric element 332, the piezoelectric element 332 contracts and pulls the needle valve 331 in a direction away from the nozzle 302 via the coupling 333. As a result, the needle valve 331 is positioned at a nozzle open position to open the nozzle 302. The head driving device 902 is supplied with electric power from an external power supply and functions as a voltage application unit that applies a voltage to the piezoelectric element 332. In the present embodiment, the voltage VH is an example of a “first voltage” according to the present disclosure, and the voltage VL is an example of a “second voltage” according to the present disclosure.

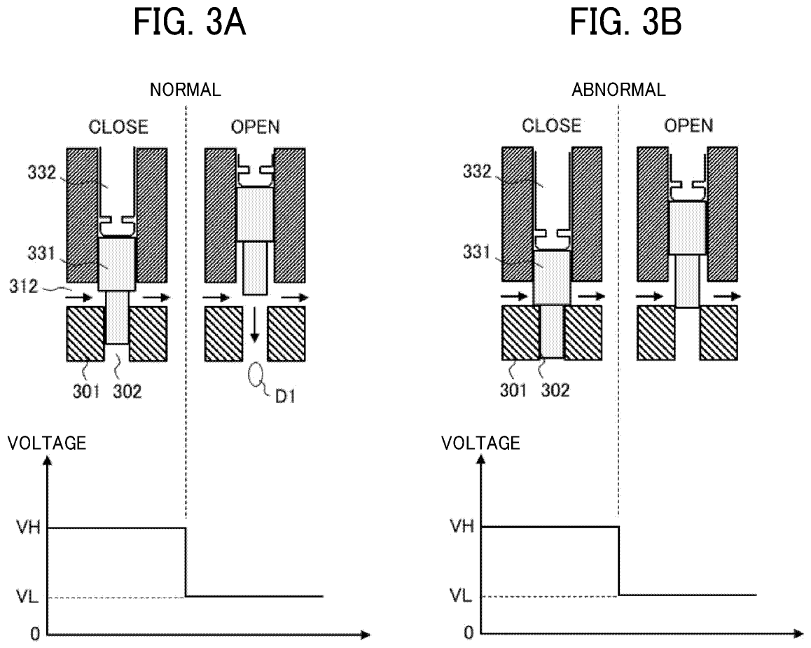

FIGS. 3A and 3B are schematic enlarged views of a part of the liquid discharge module 330 and graphs of a voltage applied to the piezoelectric element 332 when the needle valve 331 opens and closes the nozzle 302.

The liquid discharge module 330 according to the present embodiment is designed according to a specification in which the needle valve 331 moves to the nozzle open position when the voltage VL is applied to the piezoelectric element 332 as described above. Accordingly, when the voltage VH is applied to the piezoelectric element 332, the needle valve 331 is positioned at the nozzle close position as illustrated in FIG. 3A. Thus, even if liquid is supplied to the liquid chamber 312, the liquid is not discharged from the nozzle 302. When the voltage VL lower than the voltage VH is applied to the piezoelectric elements 332, the needle valve 331 is positioned at the nozzle open position, and thus liquid supplied to the liquid chamber 312 is discharged as a droplet D1 from the nozzle 302.

However, if the piezoelectric element 332 generates heat due to long-time driving at a high frequency and thermally expands, an amount of the thermal expansion of the piezoelectric element 332 excessively pushes out the needle valve 331 toward the nozzle 302 as illustrated in FIG. 3B. In this state, even if the voltage VH or VL having the same value as that at a normal state is applied to the piezoelectric element 332, the needle valve 331 may not move to the nozzle open position, causing the liquid discharge module 330 to fail to discharge liquid (i.e., discharge failure). Therefore, in the present embodiment, the voltage applied to the piezoelectric element 332 is corrected using the thermistor 334 described above to prevent the discharge failure caused by the thermal expansion of the piezoelectric element 332 (i.e., voltage correction). The voltage correction for the piezoelectric element 332 is described below.

In FIGS. 3A and 3B, the tip of the needle valve 331 fits into the nozzle 302, but the shape of the needle valve 331 is not limited thereto. In another embodiment, the entire surface of the tip of the needle valve 331 may contact the upper surface of the nozzle plate 301, and the needle valve 331 may move between a position in contact with the upper surface of the nozzle plate 301 and a position separated upward from the upper surface of the nozzle plate 301.

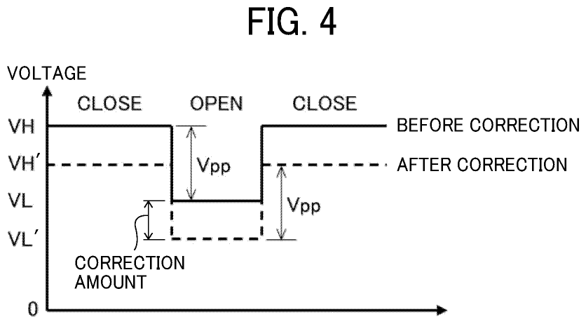

FIG. 4 is a graph of the voltages applied to the piezoelectric element 332 before and after the voltage correction.

In the present embodiment, when thermal expansion occurs in the piezoelectric element 332, the voltages VH and VL applied to the piezoelectric element 332 indicated by solid line in FIG. 4 are corrected to voltages VH′ and VL′ indicated by broken line in FIG. 4 based on correction values calculated from equations described later. Thus, the piezoelectric element 332 thermally expanding does not excessively push the needle valve 331 toward the nozzle 302, thereby maintaining the normal state illustrated in FIG. 3A. In the voltage correction, a potential difference Vpp between the voltage VH (VH′) and the voltage VL (VL′) is not necessarily constant. However, the potential difference Vpp is preferably constant as illustrated in FIG. 4 to reduce variations in the discharge properties (discharge amount, discharge speed, and the like) of the liquid before and after the voltage correction.

Next, a description is given of an example of calculation of the correction value of the voltage applied to the piezoelectric element 332. The thermistor 334 illustrated in FIG. 2 is attached to the piezoelectric element 332, for example, and detects the temperature of the piezoelectric element 332. The head driving device 902, which is described later, calculates an amount of expansion with temperature (thermal expansion) of the piezoelectric element 332 based on a detection result of the thermistor 334 and a thermal expansion coefficient of the piezoelectric element 332. Since the amount of expansion of the piezoelectric element 332 is proportional to the voltage and the temperature, respectively, the amount of expansion can be expressed by the following equations.

$$x = α \cdot V H \qquad Equation 1$$

$$Δ L = β \cdot Δ T \qquad Equation 2$$

Here, x represents the amount of expansion of the piezoelectric element 332, α represents a voltage coefficient, VH represents a voltage applied to the piezoelectric element 332, ΔL represents the amount of expansion with temperature of the piezoelectric element 332, β represents the thermal expansion coefficient, and ΔT represents temperature change of the piezoelectric element 332.

The amount of expansion of the piezoelectric element 332 can be corrected by subtracting ΔL from x, and a voltage applied to the piezoelectric element 332 after correction VH′ can be calculated by the following equation derived from Equation 1 and Equation 2.

$${V H}^{′} = ( x - β \cdot Δ T ) / α \qquad Equation 3$$

Here, α, β, and x are fixed values obtained from experiments, and the temperature change ΔT is controlled in real time to appropriately correct the voltage applied to the piezoelectric element 332, thereby reducing a variation in expansion and contraction of the piezoelectric element 332 due to thermal expansion. As a result, problems such as the discharge failure and liquid leakage can be prevented.

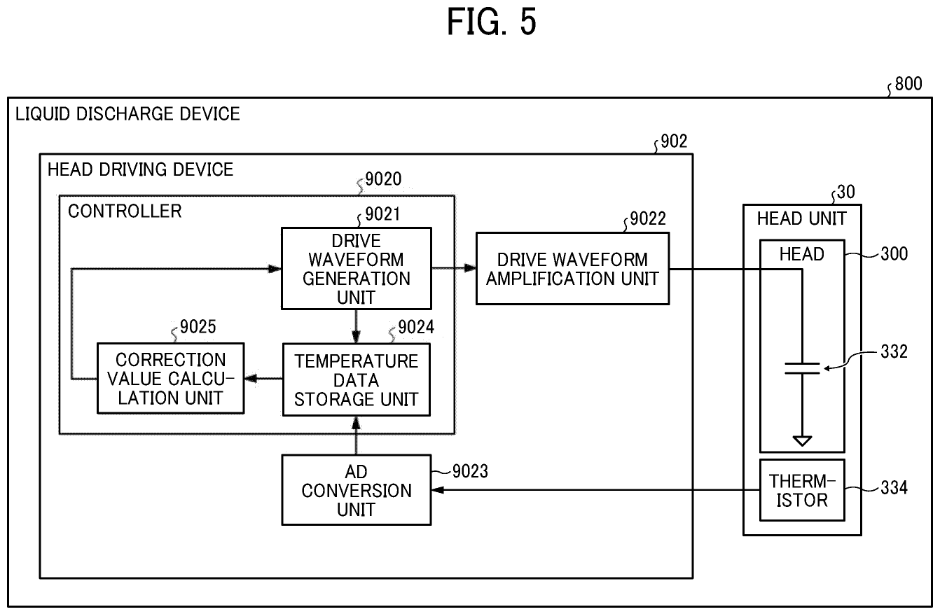

FIG. 5 is a block diagram of a liquid discharge device 800 according to the present embodiment.

The liquid discharge device 800 includes a head unit 30 and the head driving device 902 coupled to the head unit 30. A controller 9020 of the head driving device 902 mainly performs the above-described voltage correction applied to the piezoelectric element 332. The head unit 30 includes the head 300 and the thermistor 334. The head driving device 902 includes the controller 9020, a drive waveform amplification unit 9022, and an analog-to-digital (AD) conversion unit 9023. The controller 9020 includes a drive waveform generation unit 9021, a temperature data storage unit 9024, and a correction value calculation unit 9025.

The drive waveform generation unit 9021 generates a drive waveform and transmits the generated drive waveform signal to the drive waveform amplification unit 9022. The drive waveform generation unit 9021 corrects the drive waveform based on correction value data regarding the correction value of voltage applied to the piezoelectric element 332 when receiving the correction value data from the correction value calculation unit 9025. The drive waveform amplification unit 9022 amplifies the voltage and current of the drive waveform signal received from the drive waveform generation unit 9021 and applies the drive signal to the head 300 (piezoelectric element 332) of the head unit 30. That is, the drive waveform amplification unit 9022 of the head driving device 902 serves as the voltage application unit to apply a voltage to the piezoelectric element 332. The AD conversion unit 9023 performs AD conversion on the signal received from the thermistor 334 and outputs the converted signal to the temperature data storage unit 9024.

The temperature data storage unit 9024 stores data in which the temperature and the amount of expansion of the piezoelectric element 332 are associated with each other, data of the drive waveform signal received from the drive waveform generation unit 9021, and data of the signal received from the AD conversion unit 9023. The correction value calculation unit 9025 calculates a correction value based on the data received from the temperature data storage unit 9024, and transmits the calculated correction value data to the drive waveform generation unit 9021.

The head driving device 902 having the above-described configuration is provided for each of the piezoelectric elements 332 of the head 300 illustrated in FIG. 1 to correct the discharge state for each nozzle, enabling to adjust the discharge amount of the liquid, the size of the droplet, and the like for each nozzle. The controller 9020 is an example of “circuitry” in the present disclosure.

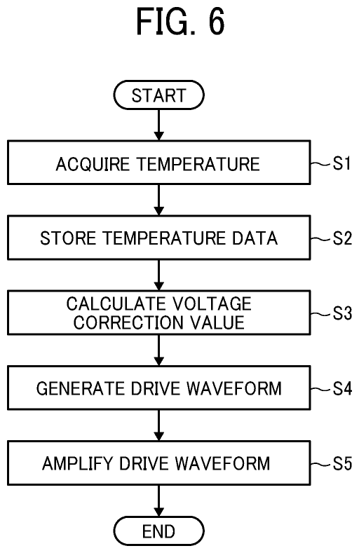

FIG. 6 is a flowchart of the voltage correction according to the present embodiment.

In the voltage correction applied to the piezoelectric element 332, the thermistor 334 starts detecting the temperature of the piezoelectric element 332 and acquires temperature data (step S1). The temperature data storage unit 9024 stores the temperature data acquired in step S1 (step S2). The correction value calculation unit 9025 calculates a correction value of the voltage applied to the piezoelectric element 332 based on data received from the temperature data storage unit 9024 (step S3).

The drive waveform generation unit 9021 generates a drive waveform based on the correction value of the voltage calculated by the correction value calculation unit 9025 (step S4). The drive waveform amplification unit 9022 amplifies the voltage and current of the drive waveform after correction (step S5), applies the amplified drive waveform to the head 300 (piezoelectric element 332) of the head unit 30 to control the operation (driving) of the head 300 in the head unit 30.

In the present embodiment, the above-described steps S1 to S5 are executed in real time, and the voltage applied to the piezoelectric element 332 is corrected following the temperature change of the piezoelectric element 332. Note that an upper limit and a lower limit may be set in the detection range of the thermistor 334 in advance, and when the thermistor 334 detects a temperature exceeding the upper limit or the lower limit, the controller 9020 may determine that the head 300 is in an abnormal state and cause the head 300 to stop discharging liquid.

As described above, according to the present embodiment, the head driving device 902 is coupled to the head unit 30 to discharge a liquid from the nozzle 302. The head driving device 902 includes the drive waveform amplification unit 9022 and the controller 9020. The drive waveform amplification unit 9022 applies a voltage to the head unit 30. The head unit 30 includes the needle valve 331 that moves between the nozzle open position to open the nozzle 302 and the nozzle close position to close the nozzle 302, the piezoelectric element 332 that moves the needle valve 331, and the thermistor 334 that detects a temperature of the piezoelectric element 332. The controller 9020 causes the drive waveform amplification unit 9022 to apply the voltage VH to the piezoelectric element 332 to move the needle valve 331 to the nozzle close position not to discharge the liquid from the nozzle 302, and causes the drive waveform amplification unit 9022 to apply the voltage VL to the piezoelectric element 332 to move the needle valve 331 to the nozzle open position to discharge the liquid from the nozzle 302. Further, the controller 9020 calculates a correction value of the voltage VL based on the temperature detected by the thermistor 334 and varies the voltage VL based on the correction value.

As described above, the controller 9020 calculates the correction value of the voltage VH based on the temperature detected by the thermistor 334 and varies the voltage VH based on the correction value. In the present embodiment, as the temperature detected by the thermistor 334 is higher, the voltage VH as the first voltage is decreased.

Accordingly, the piezoelectric element 332 expanded by thermal expansion does not excessively push the needle valve 331 toward the nozzle 302, and the head driving device 902 can be provided that prevents the discharge failure of liquid.

As described above, the controller 9020 varies the voltage VH and the voltage VL so that the potential difference Vpp between the voltage VH and the voltage VL is kept constant.

As described above, the voltage VL is set to be lower than the voltage VH. In the present embodiment, as the temperature detected by the thermistor 334 is higher, the voltage VL as the second voltage is decreased.

As a result, variations in the discharge properties (discharge amount, discharge speed, and the like) of the liquid can be reduced before and after the correction of the voltage applied to the piezoelectric element 332.

The thermistor 334 is preferably attached to the piezoelectric element 332, but alternatively, the thermistor 334 may be provided on a component in the head 300, such as the housing 310 or the coupling 333. Further, the thermistor 334 may be provided at a place separated from the head 300 in the liquid discharge apparatus (printing apparatus) described later. Further, the thermistor 334 may be provided in both the head 300 and the liquid discharge apparatus (printing apparatus). In the present embodiment, detecting the temperature of the piezoelectric element 332 (i.e., an actuator) includes not only detecting the temperature by the thermistor 334 directly attached to the piezoelectric element 332 but also detecting the temperature by the thermistor 334 provided in the vicinity of the piezoelectric element 332 in the head 300 or the liquid discharge apparatus (printing apparatus).

As a method of varying the voltage VH and the voltage VL based on the detection result of the thermistor 334 which serves as the temperature detector, a method without using the correction value described above may be used. For example, the controller 9020 may store a relation between the temperature and the voltage VH and the voltage VL suitable for the temperature as a table in advance, and may cause the drive waveform amplification unit 9022 to apply the drive waveform having the voltage VH and the voltage VL corresponding to the temperature detected by the thermistor 334 to the piezoelectric element 332 based on the table.

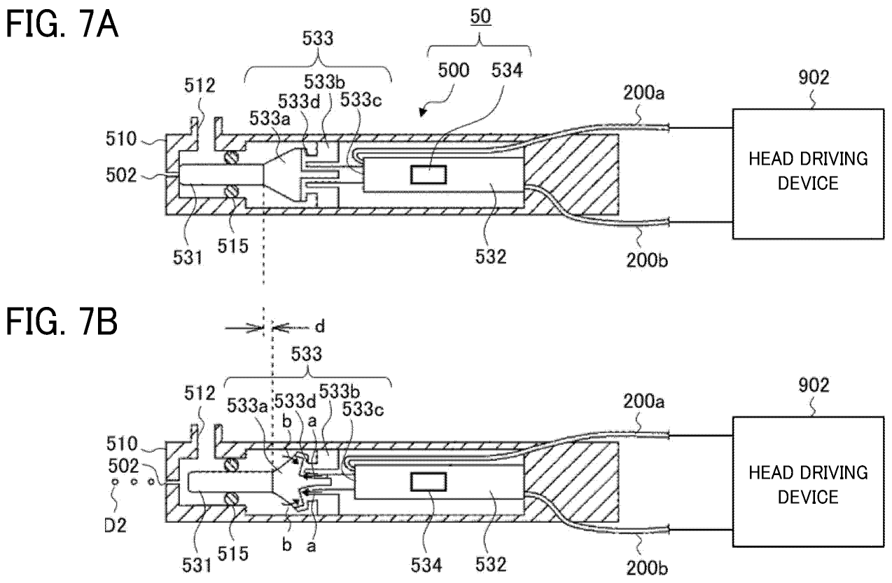

FIGS. 7A and 7B are schematic cross-sectional views illustrating a modification of the head 300 and the head driving device 902 according to the present embodiment. FIG. 7A illustrates a head 500 with a nozzle 502 closed, and FIG. 7B illustrates the head 500 with the nozzle 502 opened.

The head 500 according to the modification includes a hollow housing 510 including the nozzle 502 at a distal end of the head 500 to discharge liquid. The housing 510 further includes an injection port 512 near the nozzle 502, and the liquid is injected inside the housing 510 from the injection port 512. The head 500 further includes a needle valve 531, a piezoelectric element 532, a reverse spring mechanism 533, a sealing 515, and lead wires 200a and 200b in the housing 510. A thermistor 534 is attached to the head 500 (the piezoelectric element 532) in the housing 510. The head 500 and the thermistor 534 construct a head unit 50.

The needle valve 531 opens and closes the nozzle 502. The piezoelectric element 532 expands and contracts in the left and right directions in FIGS. 7A and 7B in response to a voltage applied from the outside. The reverse spring mechanism 533 is interposed between the needle valve 531 and the piezoelectric element 532, and transmits the expansion and contraction operation of the piezoelectric element 532 to the needle valve 531. The sealing 515 is, for example, a packing, an O-ring, or the like. The sealing 515 is fitted onto the outer circumference of the needle valve 531 to prevent the liquid from flowing to the piezoelectric element 532. The pair of lead wires 200a and 200b are connected to the electrodes of the piezoelectric element 532 to apply the voltage to the piezoelectric element 532. The thermistor 534 is attached to a portion of the piezoelectric element 532 to detect the temperature of the piezoelectric element 532. The head driving device 902 described with reference to FIG. 5 can also be used for the head unit 50 to continuously apply a drive waveform voltage to the piezoelectric element 532. In this modification, the needle valve 531 is an example of the “valve,” the piezoelectric element 532 is an example of the “actuator,” the thermistor 534 is an example of the “temperature detector,” and the reverse spring mechanism 533 is an example of a “moving mechanism” according to the present disclosure.

The reverse spring mechanism 533 is an elastic body formed of rubber, soft resin, or thin metal plate which is appropriately processed to be deformable. The reverse spring mechanism 533 includes a deformable portion 533a and a secured portion 533b. The deformable portion 533a has a substantially trapezoidal cross-section and contacts a base end (right end in FIG. 7A) of the needle valve 531. The secured portion 533b is secured to an inner wall surface of the housing 510. The reverse spring mechanism 533 further includes a guide portion 533c coupled to an end face of the piezoelectric element 532. A long side (corresponding to a lower base of the trapezoid) of the trapezoidal deformable portion 533a is a bent side 533d coupled to the secured portion 533b.

The reverse spring mechanism 533 has such a configuration, and the piezoelectric element 532 expands when a predetermined voltage is applied to the piezoelectric element 532. As the piezoelectric element 532 expands, the guide portion 533c moves toward the nozzle 502, thereby pressing the center part of the bent side 533d of the deformable portion 533a in the direction indicated by arrows a in FIG. 7B. Accordingly, the deformable portion 533a deforms such that the periphery of the bent side 533d is pulled toward the piezoelectric element 532 in the direction indicated by arrows b in FIG. 7B. Thus, the top portion, which corresponds to the upper base of the trapezoid, of the deformable portion 533a coupled to the needle valve 531 moves toward the piezoelectric element 532 as illustrated in FIG. 7B. Accordingly, the needle valve 531 is pulled toward the piezoelectric element 532 by a distance “d” as illustrated in FIG. 7B so that the nozzle 502 is opened.

A distance between the top portion of the deformable portion 533a and the bend side 533d, and a length of the bent side 533d are appropriately adjusted. The top portion of the deformable portion 533a of the reverse spring mechanism 533 serves as a coupling portion to be coupled to the needle valve 531. Thus, a moving length (moving distance) of the needle valve 531 can be made longer than an expanding length of the piezoelectric element 532. That is, the reverse spring mechanism 533 can amplify a slight expansion of the piezoelectric element 532. As a result, a production cost of the head 500 can be greatly reduced since the reverse spring mechanism 533 can reduce a length of an expensive piezoelectric element 532 to be shorter than a piezoelectric element of a conventional head. For example, if a moving distance of the needle valve 531 is set to be twice as long as a moving distance of an end face of the piezoelectric element 532, the length of the piezoelectric element 532 can be reduced to about one half (½) of the piezoelectric element of the conventional head.

As described above, when no voltage or the voltage VL is applied to the piezoelectric element 532, no external force is applied to the reverse spring mechanism 533, and thus the deformable portion 533a is not deformed as illustrated in FIG. 7A. On the other hand, when the voltage VH higher than the voltage VL is applied to the piezoelectric elements 532, the piezoelectric element 532 expands, and the guide portion 533c moves toward the nozzle 502 (in the axial direction) in response to the expansion of the piezoelectric element 532. Thus, the deformable portion 533a is deformed as illustrated in FIG. 7B in response to the movement of the guide portion 533c in the axial direction.

As described above, in this modification, when no voltage or the voltage VL is applied to the piezoelectric elements 532, the deformable portion 533a of the reverse spring mechanism 533 is in an expanded state (normal state). The needle valve 531 contacts the nozzle 502 due to the elasticity of the deformable portion 533a, and the nozzle 502 is closed by the end face of the needle valve 531. As a result, the liquid is not discharged from the nozzle 502.

On the other hand, when the voltage VH higher than the voltage VL is applied to the piezoelectric element 532, the piezoelectric element 532 expands such that the end (left end in FIG. 7B) of the piezoelectric element 532 moves in the axial direction as illustrated in FIG. 7B, and thus the guide portion 533c moves toward the nozzle 502 in the axial direction. Accordingly, the center part of the bent side 533d is pushed toward the nozzle 502 in the direction indicated by arrows a in FIG. 7B, and the periphery of the bent side 533d near the inner wall of the housing 510 is retracted toward the piezoelectric element 532 in the direction indicated by arrows b in FIG. 7B. Thus, the deformable portion 533a is in a compressed state in which the distance between the bent side 533d and the coupling portion coupled to the needle valve 531, of the deformable portion 533a is shortened, and the needle valve 531 moves toward the piezoelectric element 532 by the distance d illustrated in FIG. 7B. Accordingly, a clearance is formed between the tip of the needle valve 531 and the nozzle 502, and the nozzle 502 is opened as illustrated in FIG. 7B. As a result, the injection port 512 and the nozzle 502 communicate with each other, and the liquid is discharged from the nozzle 502 as droplets D2.

In the above-described embodiment, the needle valve 331 is positioned at the nozzle open position when the voltage VL is applied to the piezoelectric element 332, and the needle valve 331 is positioned at the nozzle close position when the voltage VH is applied to the piezoelectric element 332. On the other hand, in this modification, the relation between the applied voltage (i.e., the voltages VH and VL) and the position of the needle valve 331 (i.e., the nozzle open position and the nozzle close position) is reversed. That is, in this modification, since the reverse spring mechanism 533 is interposed between the needle valve 531 and the piezoelectric element 532, the needle valve 531 is positioned at the nozzle close position when the voltage VL is applied to the piezoelectric element 532, and the needle valve 331 is positioned at the nozzle open position when the voltage VH is applied. In this modification, the voltage VL is an example of the “first voltage” according to the present disclosure, and the voltage VH is an example of the “second voltage” according to the present disclosure.

The head driving device 902 described with reference to FIG. 5 can also be connected to the head unit 50 including the head 500 illustrated in the modification to correct the voltages VH and VL applied to the piezoelectric element 532.

As described above, according to the present modification, the head driving device 902 is coupled to the head unit 50 to discharge a liquid from the nozzle 502. The head driving device 902 includes the drive waveform amplification unit 9022 and the controller 9020. The drive waveform amplification unit 9022 applies a voltage to the head unit 50. The head unit 50 includes the needle valve 531 that moves between the nozzle open position to open the nozzle 502 and the nozzle close position to close the nozzle 502, the piezoelectric element 532 that moves the needle valve 531, and the thermistor 534 that detects a temperature of the piezoelectric element 532. The controller 9020 causes the drive waveform amplification unit 9022 to apply the voltage VL to the piezoelectric element 532 to move the needle valve 531 to the nozzle close position not to discharge the liquid from the nozzle 502, and causes the drive waveform amplification unit 9022 to apply the voltage VH to the piezoelectric element 532 to move the needle valve 531 to the nozzle open position to discharge the liquid from the nozzle 502. Further, the controller 9020 calculates a correction value of the voltage VH based on the temperature detected by the thermistor 534 of the head unit 50 and varies the voltage VH based on the correction value.

As described above, the voltage VH is set to be higher than the voltage VL. In this modification, as the temperature detected by the thermistor 534 is higher, the voltage VL as the first voltage is decreased, and the voltage VH as the second voltage is decreased.

Accordingly, the piezoelectric element 532 expanded by thermal expansion does not excessively push the needle valve 531 toward the nozzle 502, and the head driving device 902 can be provided that prevents the discharge failure of liquid.

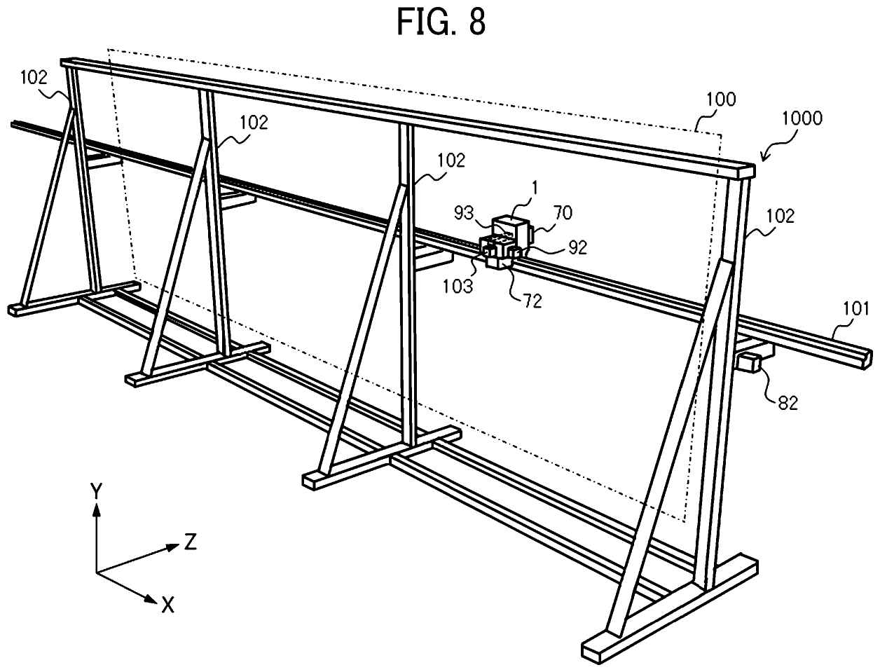

FIG. 8 is a schematic perspective view of a printing apparatus 1000 as an example of a liquid discharge apparatus according to an embodiment of the present disclosure.

The printing apparatus 1000 is installed so as to face an object 100 on which images are drawn. The object 100 is an example of the liquid application target to which liquid is applied. The printing apparatus 1000 includes an X-axis rail 101, a Y-axis rail 102 intersecting the X-axis rail 101, and a Z-axis rail 103 intersecting the X-axis rail 101 and the Y-axis rail 102. The Y-axis rail 102 movably holds the X-axis rail 101 in the Y direction (positive and negative directions). The X-axis rail 101 movably holds the Z-axis rail 103 in the X direction (positive and negative directions). The Z-axis rail 103 movably holds a carriage 1 in the Z direction (positive and negative directions).

Further, the printing apparatus 1000 includes a first Z-direction driver 92 and an X-direction driver 72. The first Z-direction driver 92 moves the carriage 1 in the Z direction along the Z-axis rail 103. The X-direction driver 72 moves the Z-axis rail 103 in the X direction along the X-axis rail 101. The printing apparatus 1000 further includes a Y-direction driver 82 that moves the X-axis rail 101 in the Y direction along the Y-axis rail 102. Further, the printing apparatus 1000 includes a second Z-direction driver 93 that moves a head holder 70 relative to the carriage 1 in the Z direction.

The printing apparatus 1000 described above discharges ink from the head 300 mounted on the head holder 70 while moving the carriage 1 in the X direction, the Y direction, and the Z direction, thereby drawing images on the object 100. The ink is an example of liquid. The movement of the carriage 1 and the head holder 70 in the 7, direction is not necessarily parallel to the Z direction, and may be an oblique movement including at least a Z direction component. Although the object 100 is flat in FIG. 8, the object 100 may have a surface shape which is a nearly vertical surface, a curved surface with the large radius of curvature, and a surface having a slight unevenness, such as a body of a car, a truck, or an aircraft. The X-axis. Y-axis, and Z-axis rails 101, 102, and 103 and the X-direction, Y-direction, first Z-direction, and second Z-direction drivers 72, 82, 92, and 93 are examples of a “moving device.”

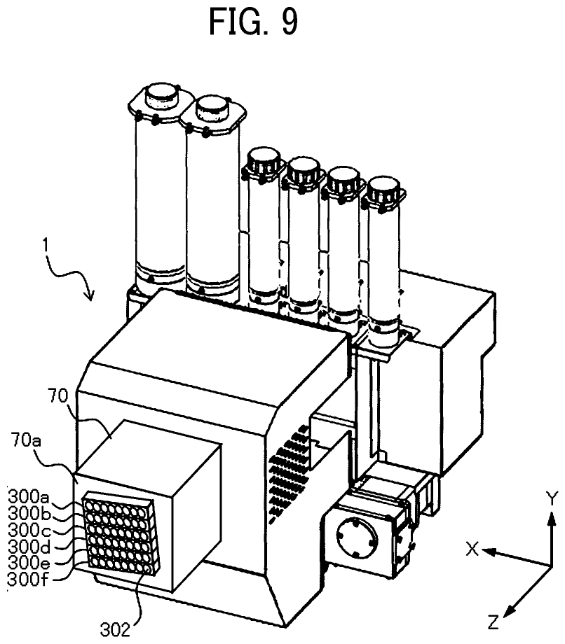

FIG. 9 is an overall perspective view of the carriage 1 of the printing apparatus 1000 illustrated in FIG. 8, in which the carriage 1 is viewed from the object 100.

The carriage 1 includes the head holder 70. The carriage 1 is movable in the Z-direction (positive and negative directions) along the Z-axis rail 103 by driving force of the first Z-direction driver 92 illustrated in FIG. 8. The head holder 70 is movable in the Z-direction (positive and negative directions) with respect to the carriage 1 by driving force of the second Z-direction driver 93 illustrated in FIG. 8. The head holder 70 includes a head fixing plate 70a to attach the head 300 to the head holder 70. In the present embodiment, six heads 300a to 300f are attached to the head fixing plate 70a and stacked one on another. Each of the heads 300a to 300f is the head 300 described with reference to FIGS. 1 to 6. The head 500 described with reference to FIGS. 7A and 7B may be attached to the head fixing plate 70a.

Each of the heads 300a to 300f includes multiple nozzles 302. The number and type of ink used in the heads 300a to 300f is not particularly limited, and the ink may be different color for each of the heads 300a to 300f or may be the same color for all the heads 300a to 300f. For example, when the printing apparatus 1000 is a coating apparatus using a single color, the inks used in the heads 300a to 300f may be the same color. The number of heads 300 is not limited to six, and may be more than six or less than six.

The heads 300a to 300f are secured to the head fixing plate 70a such that a nozzle row of each head 300 intersects the horizontal plane (i.e., X-Z plane) and the plurality of nozzles 302 is obliquely arrayed with respect to the X-axis as illustrated in FIG. 9. Thus, the head 300 discharges ink from the nozzle 302 in a direction (positive Z direction in the present embodiment) intersecting the direction of gravity.

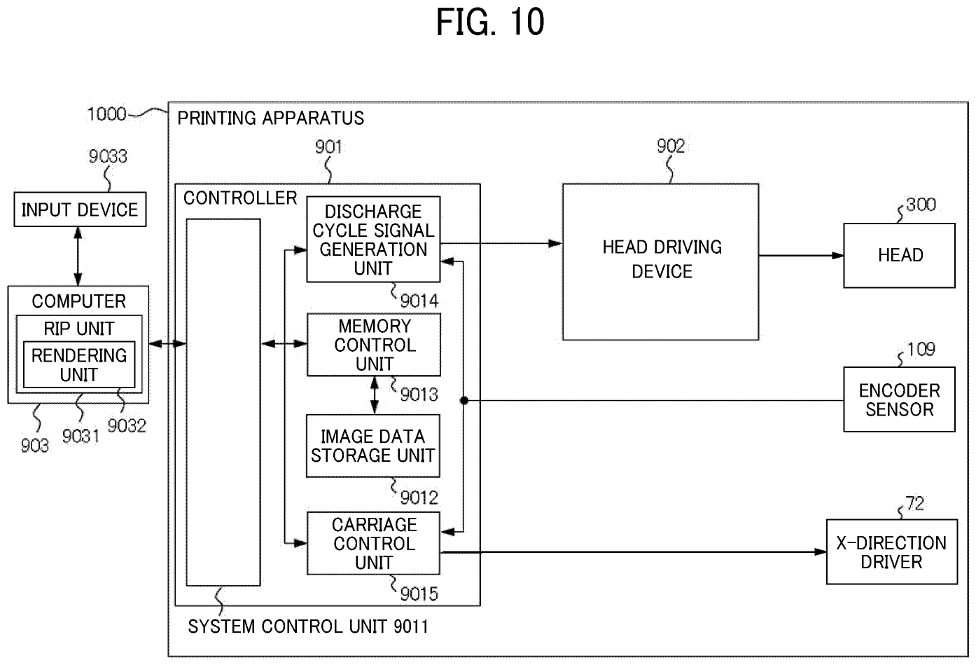

FIG. 10 is a block diagram illustrating an example of a control system of the printing apparatus 1000.

The printing apparatus 1000 as the liquid discharge apparatus includes a controller 901, the head driving device 902, and the like. A computer 903 is connected to the controller 901. The computer 903 may be a personal computer (PC). The computer 903 includes a raster image processor (RIP) unit 9031 that performs image processing in accordance with a color profile and user settings, a rendering unit 9032 that decomposes image data to be drawn on the object 100 (see FIG. 8) into image data for each scan (movement of the carriage 1 in the X-axis direction). An input device 9033 is connected to the computer 903 to set image data and coordinate data to be drawn on the object 100 and to select a drawing mode. The input device 9033 includes a keyboard, a mouse, a touch panel, and the like that receive an input from a user.

The controller 901 includes a system control unit 9011, an image data storage unit 9012, a memory control unit 9013, a discharge cycle signal generation unit 9014, a carriage control unit 9015, and the like. The system control unit 9011 receives image data and commands from the computer 903 and controls an entire operation of the printing apparatus 1000. The image data storage unit 9012 includes a memory such as a read only memory (ROM), a random access memory (RAM), or a hard disk drive (HDD), and stores image data received from the computer 903. The memory control unit 9013 controls the image data storage unit 9012.

The printing apparatus 1000 includes an encoder sensor 109 that optically detects each slit of a linear encoder installed along the X axis. The discharge cycle signal generation unit 9014 generates a discharge cycle signal for discharging liquid based on an output signal of the encoder sensor 109 and information indicating a resolution of image data received from the computer 903. The carriage control unit 9015 calculates position data of the carriage 1 based on the output signal of the encoder sensor 109 and controls a speed of the X-direction driver 72. In the present embodiment, the system control unit 9011 calculates an amount of change in a moving speed of the carriage 1. The system control unit 9011 controls the speed of the carriage 1 based on the amount of change in the moving speed of the carriage 1.

As described above, the controller 901 includes the system control unit 9011, the image data storage unit 9012, the memory control unit 9013, the discharge cycle signal generation unit 9014, the carriage control unit 9015, and the like. The controller 901 includes an arithmetic processor and a storage device, and controls the arithmetic processor to execute a program previously stored in the storage device to implement the above functional units.

Next, the head driving device 902 is described. Since the head driving device 902 that controls driving of the head 300 has been described with reference to FIG. 5, a detailed description thereof is omitted. In the head driving device 902, the drive waveform generation unit 9021 illustrated in FIG. 5 receives the discharge cycle signal from the discharge cycle signal generation unit 9014 of the controller 901. The head driving device 902 operates based on the discharge cycle signal. Note that the illustrated configuration is an example, and the present disclosure is not limited thereto. The RIP unit 9031 and the rendering unit 9032 are disposed in the computer 903 in the present embodiment, but may be disposed in the system control unit 9011 of the controller 901 in another embodiment, for example.

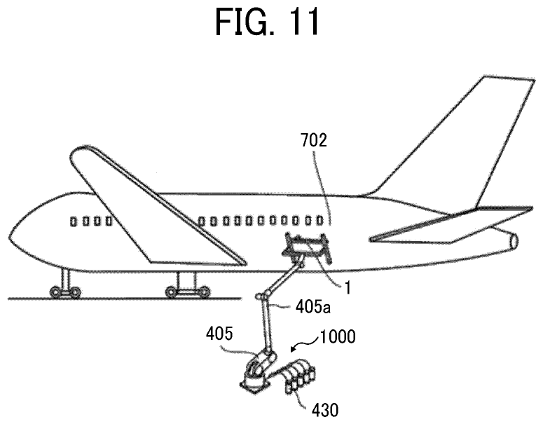

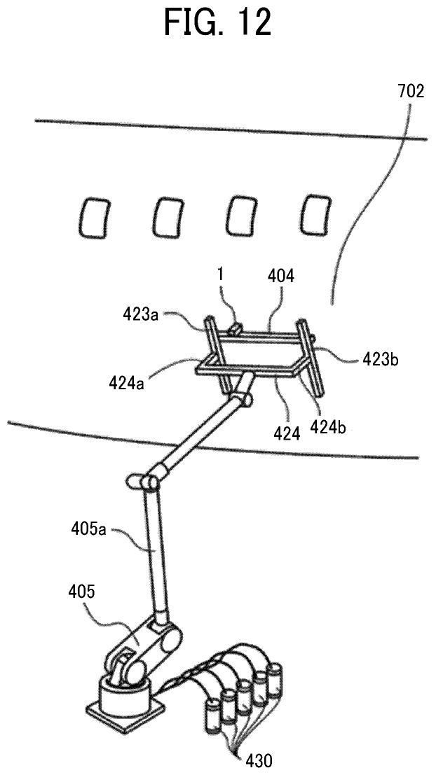

FIG. 11 is a schematic view of the printing apparatus 1000 as an example of the liquid discharge apparatus according to another embodiment of the present disclosure. FIG. 12 is an enlarged view of the printing apparatus 1000 illustrated in FIG. 11.

The printing apparatus 1000 includes a linear rail 404 and a multi-articulated robot 405. The linear rail 404 guides the carriage 1 that reciprocally and linearly moves along the linear rail 404. The multi-articulated robot 405 appropriately moves the linear rail 404 to a predetermined position and holds the linear rail 404 at the predetermined position. The multi-articulated robot 405 includes a robot arm 405a that is freely movable like a human arm by a plurality of joints. The multi-articulated robot 405 can freely move a distal end of the robot arm 405a and arrange the distal end of the robot arm 405a at an accurate position.

An industrial robot of a six-axis control-type having six axes (six joints) can be used as the multi-articulated robot 405, for example. According to the multi-articulated robot 405 of the six-axis control-type, it is possible to previously teach data related to a movement of the multi-articulated robot 405. As a result, the multi-articulated robot 405 can accurately and quickly position the linear rail 404 at a predetermined position facing a target object 702 (aircraft). The number of axes of the multi-articulated robot 405 is not limited to six, and a multi-articulated robot having an appropriate number of axes such as five axes or seven axes can be used.

The robot arm 405a of the multi-articulated robot 405 includes a fork-shaped support 424. A vertical linear rail 423a is attached to a tip of a left branch 424a of the support 424, and a vertical linear rail 423b is attached to a tip of a right branch 424b of the support 424. The vertical linear rail 423a and the vertical linear rail 423b are parallel to each other. Further, both ends of the linear rail 404 that movably holds the carriage 1 are supported by the vertical linear rails 423a and 423b to bridge between two of the vertical linear rails 423a and 423b.

The carriage 1 has the configuration in the embodiment described with reference to FIG. 9 and the like, and includes a head that discharges liquid toward the target object 702. The carriage 1 includes, for example, the head 300 described with reference to FIG. 9 and the like, a plurality of heads 300 that discharges liquids of respective colors (e.g., yellow, magenta, cyan, black, and white), or a head 300 having a plurality of nozzle rows. The liquids of respective colors are respectively supplied from ink tanks 430 to the heads 300 or the nozzle rows of the head 300 of the carriage 1. Also in this embodiment, the head 500 described with reference to FIGS. 7A and 7B may be used.

The carriage 1 moves on the linear rail 404 along a first axis. As the linear rail 404 moves on the vertical linear rails 423a and 423b, the carriage 1 moves along a second axis intersecting the first axis. The carriage 1 includes a first driver that moves the carriage 1 along a third axis intersecting the first axis and the second axis. In this modification, the head 300 discharges liquid to the target object 702 in the liquid discharge direction along the third axis. The carriage 1 further includes a second driver that moves the head 300 along the third axis with respect to the carriage 1.

In the printing apparatus 1000, the multi-articulated robot 405 moves the linear rail 404 to a desired drawing area of the target object 702, and the heads 300 are driven to draw images on the target object 702 while moving the carriage 1 along the linear rail 404 according to drawing data. When the printing apparatus 1000 ends drawing of one line, the printing apparatus 1000 causes the vertical linear rails 423a and 423b of the multi-articulated robot 405 to move the heads 300 of the carriage 1 from the one line to the next line. The printing apparatus 1000 repeats the above-described operation to draw images on the desired drawing area of the target object 702.

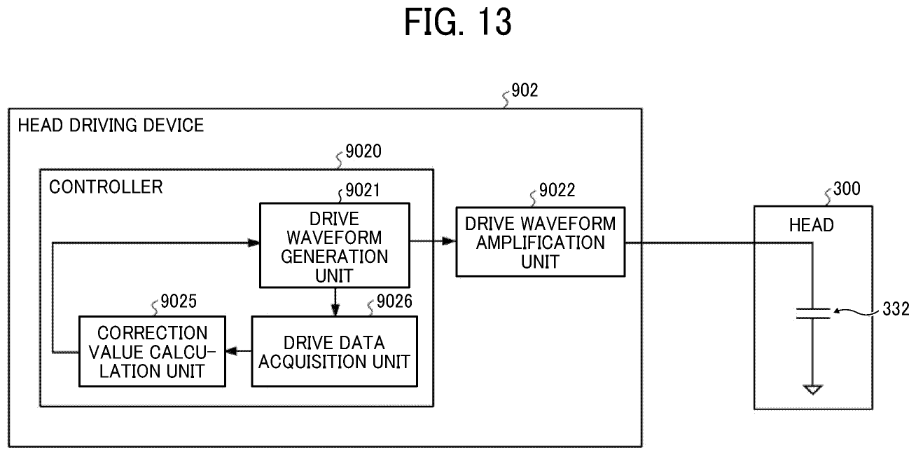

Next, anther modification of the head driving device 902 according to the present embodiment is described with reference to FIG. 13. FIG. 13 is a block diagram illustrating another modification of the head driving device 902 according to the present embodiment.

In this modification, the temperature of the head 300 (or the piezoelectric element 332) is calculated from the number of times of driving or the drive frequency of the piezoelectric element 332 without using the temperature detector such as the thermistor 334 illustrated in FIG. 5. When the piezoelectric element 332 is continuously driven, the temperature of the piezoelectric element 332 is likely to rise with the cumulative number of times of driving. In addition, the temperature of the piezoelectric element 332 is likely to rapidly rise as the drive frequency of the piezoelectric element 332 is higher. Thus, in this modification, the controller 9020 calculates (estimates) the temperature of the head 300 (or the piezoelectric elements 332) based on drive data (e.g., the number of times of driving or the drive frequency) of the piezoelectric element 332. Components may be added to or removed from the hardware configuration illustrated in FIG. 13, if desired.

In FIG. 13, the head driving device 902 includes the controller 9020 and the drive waveform amplification unit 9022. The controller 9020 includes the drive waveform generation unit 9021, a drive data acquisition unit 9026, and the correction value calculation unit 9025. The head driving device 902 can be electrically connected to the head 300.

The drive waveform generation unit 9021 generates a drive waveform and transmits the generated drive waveform signal to the drive waveform amplification unit 9022 and the drive data acquisition unit 9026. The drive waveform generation unit 9021 corrects the drive waveform based on correction value data regarding the correction value of voltage applied to the piezoelectric element 332 when receiving the correction value data from the correction value calculation unit 9025.

The drive waveform amplification unit 9022 amplifies the voltage and current of the drive waveform signal received from the drive waveform generation unit 9021, and applies a drive voltage to the piezoelectric element 332 included in the head 300.

The drive data acquisition unit 9026 receives the drive waveform signal from the drive waveform generation unit 9021, and acquires drive data such as the number of times of driving or the drive frequency of the head 300 from the drive waveform signal. Then, the drive data acquisition unit 9026 calculates the temperature of the head 300 based on the acquired drive data such as the number of times of driving or the driving frequency.

The correction value calculation unit 9025 calculates a correction value based on the data received from the drive data acquisition unit 9026, and transmits the calculated correction value data to the drive waveform generation unit 9021. The controller 9020 controls the drive voltage so that the drive voltage increases with an increase in the temperature calculated by the drive data acquisition unit 9026.

The head driving device 902 having the above-described configuration is provided for each of the piezoelectric elements 332 of the head 300 illustrated in FIG. 1 to correct the discharge state for each nozzle, enabling to adjust the discharge amount of the liquid, the size of the droplet, and the like for each nozzle. Here, the drive data acquisition unit 9026 is an example of a “drive data acquirer.”

In this modification, the head driving device 902 controls the head 300 including the needle valve 331 and the piezoelectric element 332. The needle valve 331 is moved between a position where the nozzle 302 is closed (i.e., the nozzle close position) and a position where the nozzle 302 is opened (i.e., the nozzle open position) to discharge liquid from the nozzle 302. The piezoelectric element 332 applies a driving force to the needle valve 331 to move the needle valve 331.

Similarly to the embodiment illustrated in FIGS. 3 and 4 described above, in the head 300 as the liquid discharge head, the needle valve 331 is positioned at the nozzle close position when the first voltage VH is applied to the piezoelectric element 332, and the needle valve 331 is positioned at the nozzle open position when the second voltage VL, which is different from the first voltage VH, is applied to the piezoelectric element 332.

The controller 9020 includes the drive data acquisition unit 9026 that acquires drive data such as the number of times of driving or the drive frequency of the head 300. The controller 9020 decreases the first voltage VH with an increase in the number of times of driving or the drive frequency acquired by the drive data acquisition unit 9026.

In this modification, when thermal expansion due to a large number of times of driving or high drive frequency of the piezoelectric element 332 is supposed to occur in the piezoelectric element 332, the applied voltages VH and VL indicated by solid line in FIG. 4 are corrected to lower applied voltages VH′ and VL′ indicated by broken line in FIG. 4, respectively. Thus, the piezoelectric element 332 thermally expanding does not excessively push the needle valve 331 toward the nozzle 302, thereby maintaining the normal state illustrated in FIG. 3A. Accordingly, the head driving device 902 can cause the head 300 to reliably open and close the nozzle 302 regardless of the temperature. In addition, the head driving device 902 prevents variations in discharge properties (discharge amount, discharge speed, and the like) of the liquid.

Examples of the liquid include a solution, a suspension, or an emulsion that contains, for example, a solvent, such as water or an organic solvent, a colorant, such as dye or pigment, a functional material, such as a polymerizable compound, a resin, or a surfactant, a biocompatible material, such as DNA, amino acid, protein, or calcium, or an edible material, such as a natural colorant. These liquids can be used for, e.g., inkjet ink, coating paint, surface treatment solution, a liquid for forming components of electronic element or light-emitting element or a resist pattern of electronic circuit, or a material solution for three-dimensional fabrication.

The liquid discharge apparatus according to the present embodiment is not limited to the printing apparatus 1000 described above. For example, the liquid discharge head according to the above-described embodiments of the present disclosure may be attached to a tip of a robot arm of a multi-articulated robot that can freely move like a human arm by a plurality of joints. In addition, the liquid discharge head according to the above-described embodiments may be mounted on an unmanned aerial vehicle such as a drone or a robot that can climb a wall, for example, to paint an object such as a wall. The liquid discharge apparatus is not limited to a configuration in which the liquid discharge head is moved relative to an object. A configuration in which the liquid discharge head and the object are movable relative to each other, for example, the object is moved relative to the liquid discharge head is applicable.

The above-described embodiments are one of examples and, for example, the following aspects of the present disclosure can provide the following advantages.

According to Aspect 1, a head driving device is coupled to a head unit (e.g., the head unit 30 or 50) to discharge a liquid from a nozzle (e.g., the nozzle 302 or 502). The head driving device includes a voltage application unit (e.g., the drive waveform amplification unit 9022) and circuitry (e.g., the controller 9020). The voltage application unit applies a voltage to the head unit. The head unit includes a valve (e.g., the needle valve 331 or 531) that moves between a nozzle open position to open the nozzle and a nozzle close position to close the nozzle, an actuator (e.g., the piezoelectric element 332 or 532) that moves the valve, and a temperature detector (e.g., the thermistor 334 or 534) that detects a temperature of the actuator. The circuitry causes the voltage application unit to apply a first voltage (e.g., the voltage VH in the embodiment with reference to FIGS. 1 to 6 or the voltage VL in the modification with reference to FIGS. 7A and 7B) to the actuator to move the valve to the nozzle close position not to discharge the liquid from the nozzle, causes the voltage application unit to apply a second voltage (e.g., the voltage VL in the embodiment or the voltage VH in the modification) different from the first voltage to the actuator to move the valve to the nozzle open position to discharge the liquid from the nozzle, and causes the voltage application unit to vary the second voltage based on the temperature detected by the temperature detector.

According to Aspect 2, in Aspect 1, the circuitry (e.g., the controller 9020) varies the first voltage (e.g., the voltage VH in the embodiment or the voltage VL in the modification) based on the temperature detected by the temperature detector (e.g., the thermistor 334 or 534).

According to Aspects 1 and 2, the actuator expanded by thermal expansion does not excessively push the valve toward the nozzle. Accordingly, the head driving device can be provided that prevents the discharge failure of liquid.

According to Aspect 3, in Aspect 1 or 2, the circuitry (e.g., the controller 9020) varies the first voltage (e.g., the voltage VH in the embodiment or the voltage VL in the modification) and the second voltage (e.g., the voltage VL in the embodiment or the voltage VH in the modification) while keeping a potential difference (e.g., the potential difference Vpp) between the first voltage and the second voltage constant.

According to Aspect 3, variations in the discharge properties (discharge amount, discharge speed, and the like) of the liquid can be reduced before and after the correction of the voltage applied to the actuator.

In any one of Aspects 1 to 3, the second voltage may be lower than the first voltage (i.e., Aspect 4) or may be higher than the first voltage (i.e., Aspect 5).

According to Aspect 6, a liquid discharge device includes a liquid discharge head (e.g., the head 300 or 500), a temperature detector (e.g., the thermistor 334 or 534), a voltage application unit (e.g., the drive waveform amplification unit 9022), and circuitry (e.g., the controller 9020). The liquid discharge head includes a valve (e.g., the needle valve 331 or 531) that moves between a nozzle open position to open the nozzle and a nozzle close position to close the nozzle, and an actuator (e.g., the piezoelectric element 332 or 532) that moves the valve. The temperature detector detects a temperature of the actuator. The voltage application unit applies a voltage to the actuator. The circuitry causes the voltage application unit to apply a first voltage (e.g., the voltage VH in the embodiment or the voltage VL in the modification) to the actuator to move the valve to the nozzle close position not to discharge a liquid from a nozzle (e.g., the nozzle 302 or 502), causes the voltage application unit to apply a second voltage (e.g., the voltage VL in the embodiment or the voltage VH in the modification) different from the first voltage to the actuator to move the valve to the nozzle open position to discharge the liquid from the nozzle, and causes the voltage application unit to vary the second voltage based on the temperature detected by the temperature detector.

According to Aspect 7, in Aspect 6, the circuitry (e.g., the controller 9020) varies the first voltage (e.g., the voltage VH in the embodiment or the voltage VL in the modification) based on the temperature detected by the temperature detector (e.g., the thermistor 334 or 534).

According to Aspects 6 and 7, similarly to Aspects 1 and 2, the actuator expanded by thermal expansion does not excessively push the valve toward the nozzle. Accordingly, the liquid discharge device can be provided that prevents the discharge failure of liquid.

According to Aspect 8, in Aspect 6 or 7, the circuitry (e.g., the controller 9020) varies the first voltage (e.g., the voltage VH in the embodiment or the voltage VL in the modification) and the second voltage (e.g., the voltage VL in the embodiment or the voltage VH in the modification) while keeping a potential difference (e.g., the potential difference Vpp) between the first voltage and the second voltage constant.

According to Aspect 8, variations in the discharge properties (discharge amount, discharge speed, and the like) of the liquid can be reduced before and after the correction of the voltage applied to the actuator.

In any one of Aspects 6 to 8, the second voltage may be lower than the first voltage (i.e., Aspect 9).

In the liquid discharge device according to any one of the Aspects 6 to 9, the liquid discharge head (e.g., the head 500) may include the moving mechanism (e.g., the reverse spring mechanism 533) between the valve (e.g., the needle valve 531) and the actuator (e.g., the piezoelectric element 532), and the circuitry (e.g., the controller 9020) causes the voltage application unit (e.g., the drive waveform amplification unit 9022) to apply the second voltage (e.g., the voltage VH) higher than the first voltage (e.g., the voltage VL) to the actuator to cause the moving mechanism to move the valve to the nozzle open position (i.e., Aspect 10).

In the liquid discharge device according to any one of the Aspects 6 to 10, the actuator is a piezoelectric element that expands and contracts in directions in which the valve (e.g., the needle valve 531) moves between the nozzle open position and the nozzle close position (i.e., Aspect 11).

In the liquid discharge device according to any one of Aspects 6 to 11, the nozzle includes multiple nozzles (e.g., the nozzles 302 or 502), the valve includes multiple valves (e.g., the needle valves 331 or 531) respectively open and close the multiple nozzles, and the actuator includes multiple actuators (e.g., the piezoelectric elements 332 or 532) respectively moves the multiple valves (i.e., Aspect 12).

According to Aspect 15, a method for discharging a liquid by a liquid discharge head (e.g., the head 300 or 500). The method includes moving a valve (e.g., the needle valve 331 or 531) of the liquid discharge head between a nozzle open position to open a nozzle (e.g., the nozzle 302 or 502) of the liquid discharge head and a nozzle close position to close the nozzle, applying a voltage to an actuator (e.g., the piezoelectric elements 332 or 532) of the liquid discharge head to move the valve. The applying the voltage includes: applying a first voltage (e.g., the voltage VH in the embodiment or the voltage VL in the modification) to the actuator to move the valve to the nozzle close position not to discharge the liquid from the nozzle and applying a second voltage (e.g., the voltage VL in the embodiment or the voltage VH in the modification) different from the first voltage to the actuator to move the valve to the nozzle open position to discharge the liquid from the nozzle. The method further includes detecting a temperature of the actuator and varying the second voltage based on the temperature detected by the detecting.

According to another aspect, a head driving device is coupled to a liquid discharge head (e.g., the head 300 or 500). The head driving device includes a voltage application unit (e.g., the drive waveform amplification unit 9022) and circuitry (e.g., the controller 9020). The voltage application unit applies a voltage to the liquid discharge head. The liquid discharge head includes a valve (e.g., the needle valve 331 or 531) that moves between a nozzle open position to open a nozzle (e.g., the nozzle 302 or 502) of the liquid discharge head and a nozzle close position to close the nozzle, an actuator (e.g., the piezoelectric element 332 or 532) of the liquid discharge head that moves the valve. The circuitry includes a drive data acquirer (e.g., the drive data acquisition unit 9026) to acquire drive data of the actuator (e.g., the number of times of driving or the drive frequency of the piezoelectric element 332 or 532). The circuitry causes the voltage application unit to apply a first voltage (e.g., the voltage VH in the embodiment with reference to FIGS. 1 to 6 or the voltage VL in the modification with reference to FIGS. 7A and 7B) to the actuator to move the valve to the nozzle close position not to discharge the liquid from the nozzle, causes the voltage application unit to apply a second voltage (e.g., the voltage VL in the embodiment or the voltage VH in the modification described above) different from the first voltage to the actuator to move the valve to the nozzle open position to discharge the liquid from the nozzle, and causes the voltage application unit to vary the second voltage based on an output from the drive data acquirer.

Also in this aspect, the actuator expanded by thermal expansion does not excessively push the valve toward the nozzle. Accordingly, the head driving device prevents the liquid discharge head from failing to discharge liquid.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium also includes a storage medium for storing processor readable code such as a floppy disk, a hard disk, a compact disc read-only memory (CD-ROM), a magnetic tape device, or a solid state memory device.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

This patent application is based on and claims priority to Japanese Patent Application Nos. 2021-134726, filed on Aug. 20, 2021 and 2022-066048, filed on Apr. 13, 2022, in the Japan Patent Office, the entire disclosure of each of which is hereby incorporated by reference herein.

### REFERENCE SIGNS LIST

30, 50 Head unit
300 Liquid discharge head
302 Nozzle
331 Needle valve (an example of a valve)
332, 532 Piezoelectric element (an example of an actuator)
334 Thermistor (an example of a temperature detector)
800 Liquid discharge device
902 Head driving device
9020 controller (an example of circuitry)
9021 Drive waveform generation unit
9022 Drive waveform amplification unit
9023 AD conversion unit
9024 Temperature data storage unit
9025 Correction value calculation unit
9026 Drive data acquisition unit
1000 Printing Apparatus (an example of a liquid discharge apparatus)

1. A head driving device coupled to a head unit to discharge a liquid from a nozzle, the head driving device comprising:
voltage application circuitry configured to apply a voltage to the head unit,
the head unit including:
a valve to move between a nozzle open position to open the nozzle and a nozzle close position to close the nozzle;
an actuator to move the valve; and
a temperature detector to detect a temperature of the actuator; and
circuitry configured to:
cause the voltage application circuitry to apply a first voltage to the actuator to move the valve to the nozzle close position not to discharge the liquid from the nozzle;
cause the voltage application circuitry to apply a second voltage different from the first voltage to the actuator to move the valve to the nozzle open position to discharge the liquid from the nozzle; and
cause the voltage application circuitry to vary the second voltage based on the temperature detected by the temperature detector.

2. The head driving device according to claim 1,
wherein the circuitry is configured to vary the first voltage based on the temperature detected by the temperature detector.

3. The head driving device according to claim 2,
wherein the circuitry is configured to vary the first voltage and the second voltage while keeping a potential difference between the first voltage and the second voltage constant.

4. The head driving device according to claim 1,
wherein the second voltage is lower than the first voltage.

5. The head driving device according to claim 1,
wherein the second voltage is higher than the first voltage.

6. A liquid discharge device comprising:
a liquid discharge head including:
a valve to move between a nozzle open position to open a nozzle and a nozzle close position to close the nozzle; and
an actuator to move the valve;
a temperature detector to detect a temperature of the actuator;
voltage application circuitry configured to apply a voltage to the actuator; and
circuitry configured to:
cause the voltage application circuitry to apply a first voltage to the actuator to move the valve to the nozzle close position not to discharge the liquid from the nozzle;
cause the voltage application circuitry to apply a second voltage different from the first voltage to the actuator to move the valve to the nozzle open position to discharge the liquid from the nozzle; and
cause the voltage application circuitry to vary the second voltage based on the temperature detected by the temperature detector.

7. The liquid discharge device according to claim 6,
wherein the circuitry is configured to vary the first voltage based on the temperature detected by the temperature detector.

8. The liquid discharge device according to claim 7,
wherein the circuitry is configured to vary the first voltage and the second voltage while keeping a potential difference between the first voltage and the second voltage constant.

9. The liquid discharge device according to claim 6,
wherein the second voltage is lower than the first voltage.

10. The liquid discharge device according to claim 6,
wherein the liquid discharge head further includes a mover between the valve and the actuator, and
the circuitry is configured to cause the voltage application circuitry to apply the second voltage higher than the first voltage to the actuator to cause the mover to move the valve to the nozzle open position.

11. The liquid discharge device according to claim 6,
wherein the actuator is a piezoelectric element configured to expand and contract in directions in which the valve moves between the nozzle open position and the nozzle close position.

12. The liquid discharge device according to claim 6,
wherein the nozzle includes multiple nozzles,
the valve includes multiple valves respectively open and close the multiple nozzles, and
the actuator includes multiple actuators respectively move the multiple valves.

13. A liquid discharge apparatus comprising:
the head driving device according to claim 1;
the head unit; and
a driver configured to relatively move the head unit and an object onto which the liquid is to be discharged.

14. A liquid discharge apparatus comprising:
the liquid discharge device according to claim 1; and
a driver to relatively move the liquid discharge head and an object onto which the liquid is to be discharged.

15. A method for discharging a liquid by a liquid discharge head, the method comprising:
moving a valve of the liquid discharge head between a nozzle open position to open a nozzle of the liquid discharge head and a nozzle close position to close the nozzle;
applying a voltage to an actuator of the liquid discharge head to move the valve, the applying the voltage comprising:
applying a first voltage to the actuator to move the valve to the nozzle close position not to discharge the liquid from the nozzle; and
applying a second voltage different from the first voltage to the actuator to move the valve to the nozzle open position to discharge the liquid from the nozzle;
detecting a temperature of the actuator; and
varying the second voltage based on the temperature detected by the detecting.
